(19) United States
(12) Patent Application Publication
(10) Pub. No.: US 2020/0032955 A1
(43) Pub. Date: Jan. 30, 2020

(54) Apparatuses Including Fixtures and/or Fixture Mounts and Related Methods

(71) Applicant: Lucifer Lighting Company, San Antonio, TX (US)

(72) Inventors: Ben Mathews, San Antonio, TX (US); Scott Dupre, Riverside, RI (US)

(21) Appl. No.: 16/289,387

(22) Filed: Feb. 28, 2019

Related U.S. Application Data
(63) Continuation of application No. 15/145,239, filed on May 3, 2016, now abandoned.
(60) Provisional application No. 62/156,318, filed on May 3, 2015.

(51) Int. Cl. F16M 13/02; F21V 21/03; F21S 2/00; H02G 3/00

(52) U.S. Cl. CPC F16M 13/027; H02G 3/00; F21S 2/00; F21V 21/03

(57) ABSTRACT

Some of the present apparatuses include a mount having a sidewall extending between first and second ends to define an interior volume and one or more openings in communication with the interior volume, one or more first clamp members disposed within the interior volume, each defining a channel in communication with a respective one of the opening(s) and configured to receive a conduit, and one or more second clamp members, each configured to be coupled to a respective one of the first clamp member(s) to secure the conduit between the clamp members. Some apparatuses include a fixture having a base, where the base of the fixture is configured to be coupled to the first end of the mount. In some apparatuses, the mount includes one or more stops, each coupled to a respective one of the clamp members and configured to limit movement of the conduit into the interior volume.

### CROSS-REFERENCES TO RELATED APPLICATIONS

This application claims priority to U.S. patent application Ser. No. 15/145,239, filed May 3, 2016, and to U.S. Provisional Patent Application No. 62/156,318, filed May 3, 2015, each entitled “APPARATUSES INCLUDING FIXTURES AND/OR FIXTURE MOUNTS AND RELATED METHODS.” The entire content of each of these applications is incorporated herein by reference.

### BACKGROUND

### 1. Field of Invention

The present invention relates generally to apparatuses including fixtures and/or fixture mounts, and more specifically, but not by way of limitation, to apparatuses including fixtures and/or fixture mounts that may be suitable for use in surface-mounted applications.

### 2. Description of Related Art

A fixture mount may be used to mount a fixture, such as, for example, a light fixture, fan, camera, speaker, microphone, detector, and/or the like, to a structure, such as, for example, a ceiling, wall, floor, other surface, and/or the like. In many instances, such a fixture mount comprises a junction box through which electrical wiring may be disposed to provide power to a fixture coupled to the fixture mount. Typically, a fixture mount is installed within, rather than mounted on, a structure. Thus, during installation, a traditional fixture mount may require a hole to be cut into a structure, thereby increasing time and/or money costs associated with installation and/or removal of the fixture mount.

Some fixture mounts, such as surface-mounted fixture mounts, may be configured to mounted on, rather than disposed within, a structure. In many instances, such a surface-mounted fixture mount may be configured to be coupled to an electrical conduit by threading the conduit into the fixture mount. However, threaded connections between a conduit and a fixture mount may complicate installation of the fixture mount. For example, when installing such a fixture mount, a threaded connection between a conduit and the fixture mount may necessitate the ready availability of conduits of pre-determined lengths (e.g., between threaded portions), thread pitches, and/or the like, additional couplers, and/or the like.

Many such surface-mounted fixture mounts may employ external (e.g., to housings of the fixture mounts) conduit and/or fixture mounting hardware. Such external mounting hardware may consume an undesirable amount of space, be unsightly, and/or the like.

Examples of junction boxes are disclosed in (1) U.S. Pat. No. 915,990; and (2) U.S. Pat. No. 6,232,553.

### SUMMARY

Some embodiments of the present apparatuses may be suitable for use in surface-mounted applications through, for example: (1) a mount including a first clamp member disposed within an interior volume of the mount and a second clamp member configured to be disposed within the interior volume, where the second clamp member is configured to be coupled to the first clamp member to secure a conduit between the first and second clamp members; and/or (2) a mount having a sidewall that defines an outer perimeter of the mount and a fixture having a base with an outer perimeter that corresponds to the outer perimeter of the mount, where the fixture is configured to be coupled to the mount such that the outer perimeter of the base aligns with the outer perimeter of the mount (e.g., by providing for mounting hardware that may be hidden during use and/or a smooth and/or visually appealing transition between the mount and the fixture).

Some embodiments of the present apparatuses are configured, through a mount including a first clamp member and a second clamp member configured to be coupled to the first clamp member to secure a conduit between the first and second clamp members, to facilitate installation of the mount and/or a fixture that is configured to be coupled to the mount (e.g., by providing for a threadless interface between the conduit and the mount).

Some embodiments of the present apparatuses are configured, through a mount including one or more stops, each configured to limit movement of a conduit into an interior volume of the mount, to mitigate interferences between the conduit and other components that may be disposed within the interior volume, such as, for example, wiring.

Some embodiments of the present apparatuses comprise: a mount comprising a first end, a second end, a sidewall extending between the first end and the second end to define an interior volume, the sidewall defining one or more openings, each in communication with the interior volume, one or more first clamp members disposed within the interior volume, each defining a first channel in communication with a respective one of the one or more openings, the first channel configured to receive a conduit, and one or more second clamp members, each configured to be coupled to a respective one of the one or more first clamp members to secure the conduit between the second clamp member and the respective one of the one or more first clamp members. In some embodiments, the sidewall defines the outer perimeter of the mount. In some embodiments, the sidewall of the mount defines a cylindrical surface.

In some embodiments, the second end of the mount is configured to be coupled to a surface. In some embodiments, the second end of the mount defines one or more openings configured to couple the mount to a surface.

Some embodiments comprise a fixture having a base, where the base of the fixture is configured to be coupled to the first end of the mount. In some embodiments, the base of the fixture has an outer perimeter that corresponds to the outer perimeter of the mount, and the base is configured to be coupled to the first end of the mount such that the outer perimeter of the base aligns with the outer perimeter of the mount. In some embodiments, the base of the fixture is configured to be coupled to the first end of the mount such that the base contacts the sidewall of the mount. Some embodiments comprise a tether configured to be coupled between the fixture and the mount.

Some embodiments comprise a flange configured to be coupled to the first end of the mount such that no portion of the flange extends beyond the outer perimeter of (e.g., laterally beyond the sidewall of) the mount, where the base of the fixture is configured to be coupled to the flange. In some embodiments, one of the base of the fixture and the flange comprises one or more protrusions, the other of the base and the flange defines one or more slots, and each of the one or more protrusions is configured to be received by a respective one of the one or more slots to couple the base to the flange.

In some embodiments, the first channel of at least one of the one or more first clamp members includes a cylindrical surface. In some embodiments, each of the one or more second clamp members defines a second channel configured to receive the conduit when the second clamp member is coupled to the respective one of the one or more first clamp members. In some embodiments, the second channel of at least one of the one or more second clamp members includes a cylindrical surface.

In some embodiments, the mount comprises one or more stops, each coupled to a respective one of the clamp members and configured to limit movement of the conduit into the interior volume. In some embodiments, at least one of the one or more stops is coupled to a respective one of the one or more first clamp members, the stop comprising a projection extending into the first channel. In some embodiments, at least one of the one or more stops is coupled to a respective one of the one or more second clamp members, the stop comprising a projection extending into the second channel.

In some embodiments, for each of the one or more first clamp members, no portion of the first clamp member extends laterally beyond the sidewall of the mount. In some embodiments, for each of the one or more second clamp members, no portion of the second clamp member extends laterally beyond the sidewall of the mount. In some embodiments, no portion of the mount extends laterally beyond the sidewall of the mount.

Some embodiments comprise one or more plugs, each configured to be removably coupled to the mount to selectively obstruct access to the interior volume via a respective one of the one or more openings.

Some embodiments of the present methods comprise: coupling a second end of a mount to a surface, the mount having a sidewall extending between the second end and a first end that is opposite the second end, inserting a conduit through the sidewall and into a first channel defined by a first clamp member of the mount, coupling a second clamp member to the first clamp member to secure the conduit between the first and second clamp members, and coupling a base of a fixture to the first end of the mount. In some embodiments, the second clamp member defines a second channel, and the coupling of the second clamp member to the first clamp member is performed such that the conduit is received by the second channel.

In some embodiments, the sidewall of the mount defines the outer perimeter of the mount, the base of the fixture has an outer perimeter that corresponds to the outer perimeter of the mount, and the coupling of the base of the fixture to the first end of the mount is performed such that the outer perimeter of the base aligns with the outer perimeter of the mount. In some embodiments, the coupling of the base of the fixture to the first end of the mount is performed such that the base contacts the sidewall of the mount. Some embodiments comprise coupling a tether between the fixture and the mount.

Some embodiments comprise coupling a flange to the first end of the mount such that no portion of the flange extends laterally beyond the sidewall of the mount. In some embodiments, one of the base of the fixture and the flange comprises one or more protrusions, the other of the base and the flange defines one or more slots, and the coupling of the base of the fixture to the first end of the mount comprises receiving, in each of the one or more slots, a respective one of the one or more protrusions, and rotating the base relative to the flange to couple the base to the mount.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the term “substantially” may be substituted with “within [a percentage] of” what is specified, where the percentage includes 0.1, 1, 5, and 10 percent.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus that “comprises,” “has,” or “includes” one or more elements possesses those one or more elements, but is not limited to possessing only those elements. Likewise, a method that “comprises,” “has,” or “includes” one or more steps possesses those one or more steps, but is not limited to possessing only those one or more steps.

Any embodiment of any of the apparatuses, systems, and methods can consist of or consist essentially of—rather than comprise/have/include—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Some details associated with the embodiments described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures are drawn to scale (unless otherwise noted), meaning the sizes of the depicted elements are accurate relative to each other for at least the embodiment depicted in the figures.

FIG. 1A is a perspective view of a first embodiment of the present apparatuses.

FIGS. 1B-1E are top, bottom, side, and front views, respectively, of the apparatus of FIG. 1A.

FIG. 1F is a cross-sectional side view of the apparatus of FIG. 1A, taken along the line 1F-1F of FIG. 1B.

FIG. 2 is a perspective view of the apparatus of FIG. 1A, shown with a plug.

FIGS. 3A-3C are front perspective, back perspective, and side views, respectively, of a plug, which may be suitable for use with some embodiments of the present apparatuses.

FIG. 4 is a top view of the apparatus of FIG. 1A, shown with a flange.

FIG. 5 is a perspective view of the apparatus of FIG. 4, shown with a tether.

FIG. 6 is a perspective view of a second embodiment of the present apparatuses, depicting one example of a coupling between a mount and a fixture.

FIG. 7 is a perspective view of the second embodiment.

FIG. 8 is a perspective view of two of the second embodiment, including a conduit disposed between the apparatuses.

### DETAILED DESCRIPTION OF ILLUSTRATIVE EMBODIMENTS

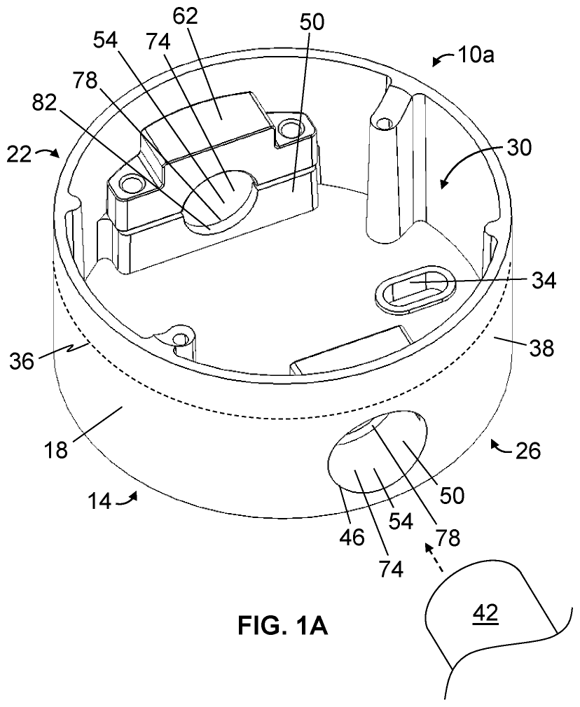

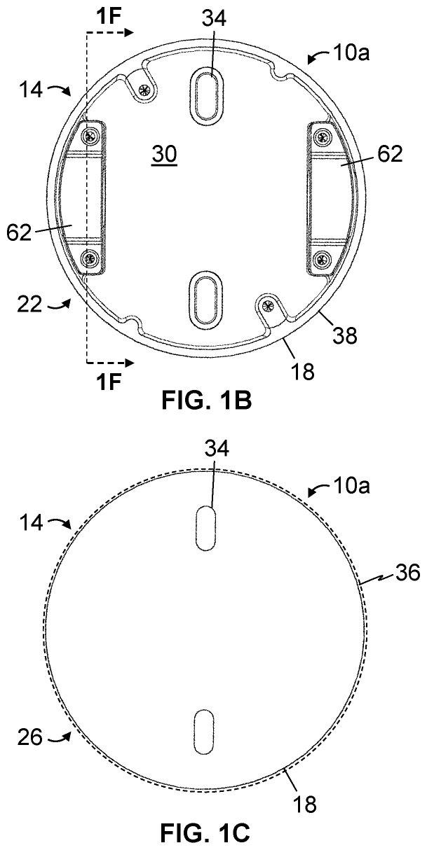

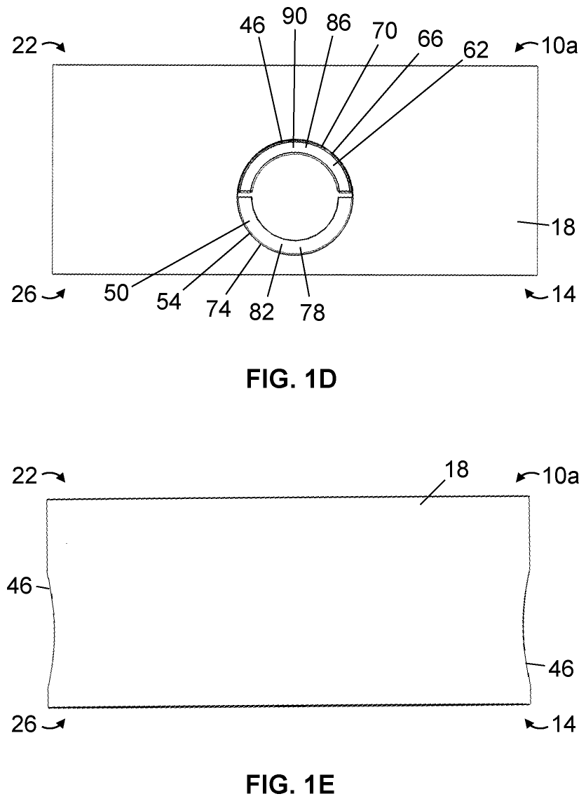

Referring now to the figures, and more particularly to FIGS. 1A-1F, shown therein and designated by the reference numeral 10a is a first embodiment of the present apparatuses. In the embodiment shown, apparatus 10a comprises a mount 14 for a fixture (e.g., a light fixture, fan, camera, speaker, microphone, detector, and/or the like). For example, in this embodiment, mount 14 comprises a sidewall 18 extending between a first end 22 configured to be coupled to a fixture (e.g., 130, described in more detail below) and a second end 26 configured to be coupled to a surface (e.g., ceiling, wall, floor, other surface, and/or the like) to define an interior volume 30. In the depicted embodiment, second end 26 of mount 14 defines one or more openings 34 configured to allow coupling of the mount to a surface. For example, in the embodiment shown, one or more fasteners (e.g., screws, bolts, rivets, studs, and/or the like) may be disposed through one or more openings 34 and within a surface to couple the mount to the surface. In this embodiment, each of one or more openings 34 is defined by second end 26 of mount 14 such that the opening is in communication with interior volume 30 (e.g., each of the one or more openings is defined within an outer perimeter 36 of sidewall 18). In at least this way, mount 14 may be coupled to a surface, and mounting hardware coupling the mount to the surface, such as, for example, one or more fasteners disposed through one or more openings 34, may be hidden from view when the mount is in use (e.g., when a fixture, such as, for example, fixture 130, is coupled to the mount). In other embodiments, respective mounts (e.g., 14) of the present apparatuses (e.g., 10a, 10b, and/or the like) may be configured to be coupled to a surface in any suitable fashion, such as, for example, via adhesive and/or the like.

In the depicted embodiment, outer perimeter 36 of sidewall 18 of mount 14 has curved portions (e.g., the sidewall defines a cylindrical outer surface 38); however, in other embodiments, a respective mount (e.g., 14) may comprise any suitable shape, such as, for example, having a sidewall (e.g., 18) defining an outer perimeter (e.g., 36) having straight and/or curved portions (e.g., including an outer perimeter that is triangular, square, rectangular, and/or otherwise polygonal, circular, elliptical, and/or otherwise rounded, and/or the like).

In the embodiment shown, mount 14 is configured to be coupled to one or more conduits 42, which may contain electrical wiring configured to communicate power to and/or from the mount and/or a fixture (e.g., 130) that is coupled to the mount (e.g., such that the mount may function as a junction box). For example, in this embodiment, sidewall 18 defines one or more openings 46, each in communication with interior volume 30 and configured (e.g., sized) to receive a conduit 42.

In the depicted embodiment, mount 14 is configured to secure one or more conduits 42 relative to the mount. For example, in the embodiment shown, mount 14 comprises one or more first clamp members 50 disposed within interior volume 30, each defining a first channel 54 in communication with a respective one of one or more openings 46 and configured to receive a conduit 42 via the opening. To illustrate, in this embodiment, one of one or more conduits 42 may be disposed through one of one or more openings 46 and be received by a first channel 54 of a respective one of one or more first clamp members 50. As shown, each of one or more first clamp members 50 is coupled to (e.g., unitary with) sidewall 18; however, in other embodiments, respective mounts (e.g., 14) of the present apparatuses (e.g., 10a, 10b, and/or the like) may comprise one or more first clamp members (e.g., 50) that are spaced apart from, but otherwise surrounded by, a sidewall (e.g., 18).

In the embodiment shown, mount 14 comprises one or more second clamp members 62, each configured to be coupled to a respective one of one or more first clamp members 50 to secure a respective one of one or more conduits 42 between the second clamp member and the respective first clamp member (e.g., via transverse and/or radial compression of the respective conduit between the second clamp member and the respective first clamp member). For example, in this embodiment, each of one or more second clamp members 62 is configured to be coupled to a respective one of one or more first clamp members 50 via (e.g., threaded) fastener(s), which may be disposed through the second clamp member and into the respective first clamp member. In at least this way, mount 14 may be configured to facilitate installation of the mount and/or a fixture that is configured to be coupled to the mount (e.g., by providing for threadless interface(s) between one or more conduits 42 and the mount).

In the depicted embodiment, each of one or more second clamp members 62 defines a second channel 66 configured to receive one of one or more conduits 42 when the second clamp member is coupled to a respective one of one or more first clamp members 50 (FIG. 1F). In the embodiment shown, mount 14 is configured to receive one or more generally cylindrical conduits 42 and second channel 66 of each of one or more second clamp members 62 defines a cylindrical surface 70 and/or first channel 54 of each of one or more first clamp members 50 defines a cylindrical surface 74. In at least this way, mount 14, and more particularly, one or more second clamp members 62 and/or one or more first clamp members 50, may be configured to secure one or more conduits 42 relative to the mount, while reducing the risk of crushing and/or otherwise undesirably deforming the one or more conduits.

In the depicted embodiment, mount 14 includes one or more stops (e.g., 78, 86), each coupled to a respective one of clamp members 50 and 62 and configured to limit movement of a respective one of one or more conduits 42 into interior volume 30 of mount 14. For example, in the embodiment shown, at least one of one or more stops (e.g., 78) is coupled to a respective one of one or more first clamp members 50, the stop comprising a projection 82 (e.g., a ridge) extending into first channel 54. Similarly, in this embodiment, at least one of one or more stops (e.g., 86) is coupled to a respective one of one or more second clamp members 62, the stop comprising a projection 90 (e.g., a ridge) extending into second channel 66. However, in other embodiments of the present apparatuses (e.g., 10a, 10b, and/or the like), stop(s) (e.g., 78, 86 and/or the like) of a respective mount (e.g., 14) may comprise any suitable structure, such as, for example, protrusion(s) and/or fastener(s) disposed within an interior volume (e.g., 30) of the respective mount that extend along a direction defined between a second end (e.g., 26) and a first end (e.g., 22) of the respective mount, where the protrusion(s) and/or fastener(s) are located between respective one(s) of one or more openings (e.g., 46) and at least a portion of the interior volume of the respective mount. In these ways and others, mount 14, and more particularly, stop(s) 78 and/or stop(s) 86, may be configured to facilitate coupling of one or more conduits 42 to the mount (e.g., by facilitating the insertion of a sufficient portion of each of the one or more conduits into a first channel 54 of a respective one of one or more first clamp members 50, and, in some embodiments, into a second channel 66 of a respective one of one or more second clamp members 62, while mitigating interferences between the conduit and other components that may be disposed within interior volume 30 of the mount, such as, for example, wiring, that may otherwise be caused by over-insertion of the conduit into the mount).

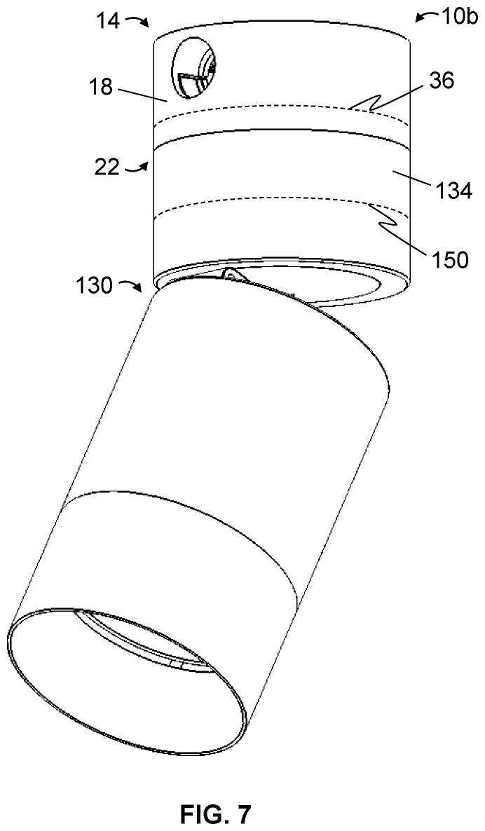

In the embodiment shown, sidewall 18 defines the outermost lateral boundary of mount 14 (e.g., no portion of the mount extends laterally beyond outer perimeter 36 of the sidewall). For example, in this embodiment, no portion of each of one or more first clamp members 50 extends laterally beyond sidewall 18 of mount 14 (e.g., beyond outer perimeter 36) and/or no portion of each of one or more second clamp members 62 extends laterally beyond the sidewall of the mount (e.g., beyond the outer perimeter). In these ways and others, mount 14 may be configured to secure one or more conduits 42 between respective ones of one or more first clamp members 50 and respective ones of one or more second clamp members 62, and the respective first and second clamp member(s) may be hidden from view when the mount is in use (e.g., when a fixture, such as fixture 130, is coupled to the mount, as shown in FIG. 7 for apparatus 10b).

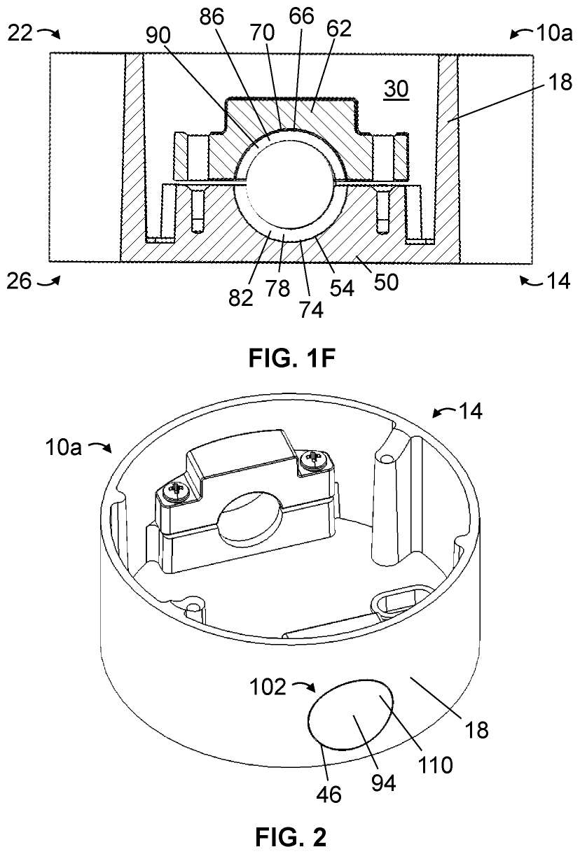

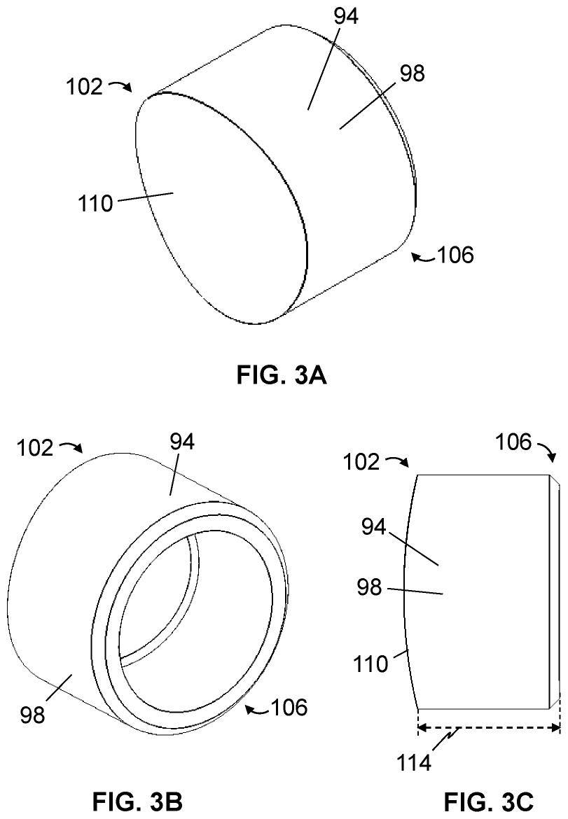

Referring additionally to FIG. 2, in the embodiment shown, apparatus 10a comprises one or more plugs 94, each configured to be removably coupled to mount 14 (e.g., inserted into a respective one of one or more openings 46, into a first channel 54 of a respective one of one or more first clamp members 50, and/or into a second channel 66 of a respective one of one or more second clamp members 62) to selectively obstruct access to interior volume 30 via a respective one of one or more openings 46. For example, and referring additionally to FIGS. 3A-3C, in this embodiment, each of one or more plugs 94 comprises a sidewall 98 that extends between a first end 102 of the plug and a second end 106 of the plug. In the depicted embodiment, first end 102 of each of one or more plugs 94 defines an outer surface 110 configured to correspond to an outer surface of sidewall 18 of mount 14 (e.g., such that, when the plug is coupled to the mount, there is a smooth, flush, and/or visually appealing transition between the outer surface of the plug and the outer surface of the sidewall of the mount). In the embodiment shown, a length 114 associated with sidewall 98 of each of one or more plugs 94 is configured (e.g., dimensioned) to correspond to a length of a first channel 54 of a respective one of one or more first clamp members 50 (e.g., excluding stop 78, if present) and/or to a length of a second channel 66 of a respective one of one or more second clamp members 62 (e.g., excluding stop 86, if present) (e.g., to facilitate coupling of the plug to mount 14 such that first end 102 of the plug is flush with sidewall 18 of the mount).

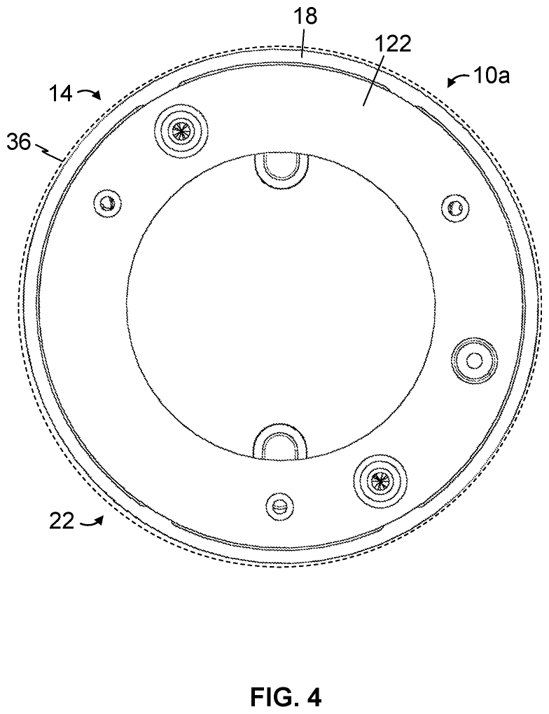

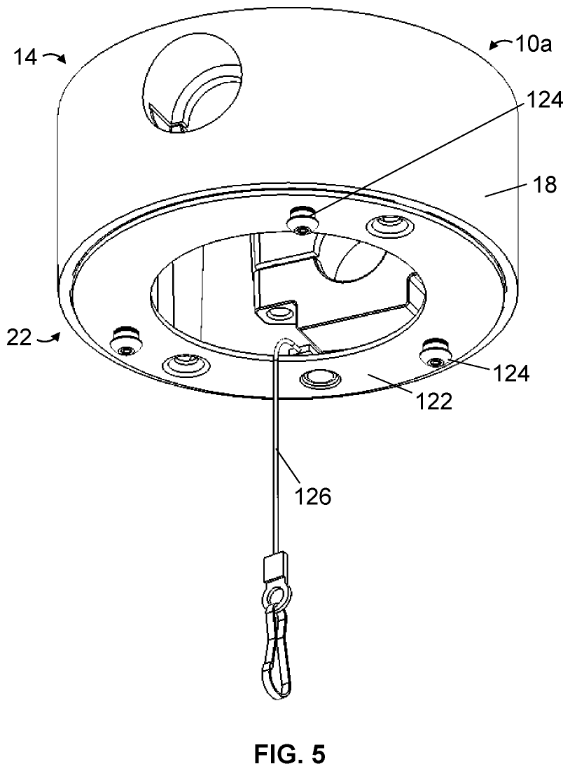

Referring additionally to FIGS. 4 and 5, in the embodiment shown, apparatus 10a comprises a flange 122 configured to be coupled to first end 22 of mount 14 (e.g., via fasteners, such as, for example, screws, bolts, rivets, and/or the like, integral formation, and/or the like). In this embodiment, flange 122 is configured to be coupled to a fixture (e.g., 130) (e.g., via one or more protrusions 124 that extend from the flange, as described in more detail below with respect to apparatus 10b). As shown, in the depicted embodiment, flange 122 is configured (e.g., sized) to be coupled to first end 22 of mount 14 such that no portion of the flange extends laterally beyond sidewall 18 the mount (e.g., beyond outer perimeter 36). In at least this way, mount 14, and more particularly, flange 122, may be configured such that the flange and/or any fixture mounting hardware associated with the flange may be hidden from view when the mount is in use (e.g., when a fixture, such as fixture 130 is coupled to the mount via the flange). Also depicted in FIG. 5, in the embodiment shown, apparatus 10a comprises a tether 126 configured to be coupled between mount 14 and a fixture (e.g., 130) (e.g., to facilitate installation of the mount and/or fixture, reduce a risk of damage and/or injury that might otherwise result if the fixture becomes decoupled from the mount, and/or the like).

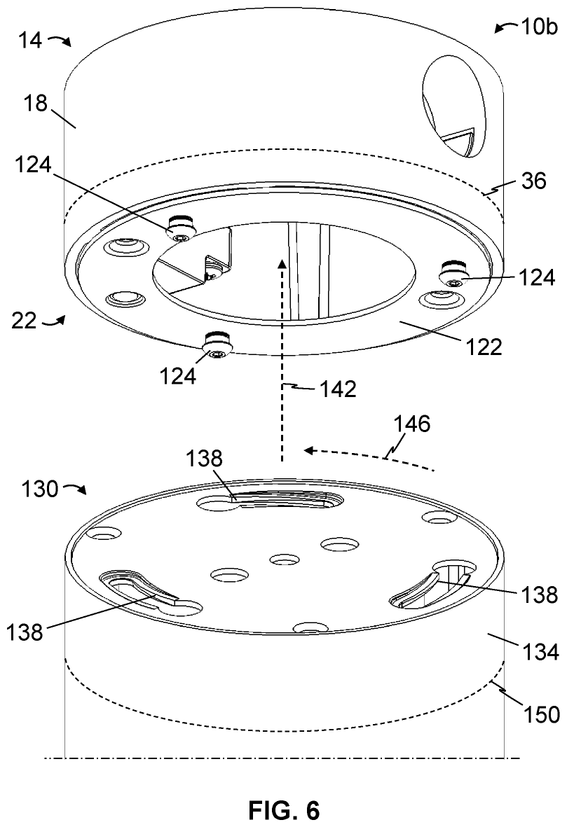

Referring now to FIGS. 6 and 7, shown therein and designated by the reference numeral 10b is a second embodiment of the present apparatuses. Apparatus 10b is substantially similar to apparatus 10a, with the primary exception that apparatus 10b comprises a fixture 130. In the embodiment shown, fixture 130 comprises a light fixture; however, in other embodiments, the present apparatuses (e.g., 10b) may comprise any suitable fixture (e.g., 130), such as, for example, a fan, camera, speaker, microphone, detector, and/or the like.

In this embodiment, fixture 130 includes a base 134 configured to be (e.g., removably) coupled to first end 22 of mount 14 (e.g., via flange 122). For example, in the depicted embodiment, base 134 of fixture 130 defines one or more slots 138, each configured to receive a respective one of one or more protrusions 124 of flange 122 to removably couple the fixture to the mount; however, in other embodiments of the present apparatuses (e.g., 10b), a flange (e.g., 122) of a respective mount (e.g., 14) may define one or more slots (e.g., 138) and a base (e.g., 134) of a respective fixture (e.g., 130) may define one or more protrusions (e.g., 124), each configured to be received by a respective one of the one or more slots to couple the respective fixture to the respective mount. To illustrate, in the embodiment shown, base 134 of fixture 130 may be moved relative to mount 14 (e.g., generally in a direction indicated by arrow 142) until each of one or more protrusions 124 of flange 122 is received by a respective one of one or more slots 138 of the base of the fixture, and the base of the fixture may be rotated relative to the mount (e.g., generally in a direction indicated by arrow 146) to secure the base of the fixture relative to the mount. In yet other embodiments, a respective fixture (e.g., 130) may be coupled to a respective mount (e.g., 14) in any suitable fashion, such as, for example, via fasteners (e.g., screws, bolts, rivets, studs, and/or the like), integral formation of at least a portion of a base (e.g., 134) of the respective fixture with at least a portion of the respective mount, such as, for example, at least a portion of a sidewall (e.g., 18) of the respective mount, and/or the like.

In this embodiment, base 134 of fixture 130 has an outer perimeter 150 that corresponds to outer perimeter 36 of sidewall 18 of mount 14. Outer perimeter 150 may correspond to outer perimeter 36 in that, for example, outer perimeter 150 may have substantially the same shape, dimension(s), and/or the like as outer perimeter 36, when base 134 is coupled to mount 14, sidewall 18 of the mount, or at least a portion thereof, is level or flush with (though not necessarily in contact with) an outer surface of the base, and/or the like. In the depicted embodiment, base 134 of fixture 130 is configured to be coupled to first end 22 of mount 14 such that outer perimeter 150 of the base of the fixture aligns with outer perimeter 36 of sidewall 18 the mount (e.g., such that the base of the fixture is centered relative to the mount, a longitudinal axis of the base of the fixture is aligned with a longitudinal axis of the mount, and/or the like). In the embodiment shown, base 134 of fixture 130 is configured to be coupled to first end 22 of mount 14 such that the base of the fixture contacts sidewall 18 of the mount. In these ways and others, apparatus 10b, and more particularly, base 134 of fixture 130 and sidewall 18 of mount 14, may be configured to provide for a smooth and/or visually appealing transition between the mount and the fixture when the fixture is coupled to the mount.

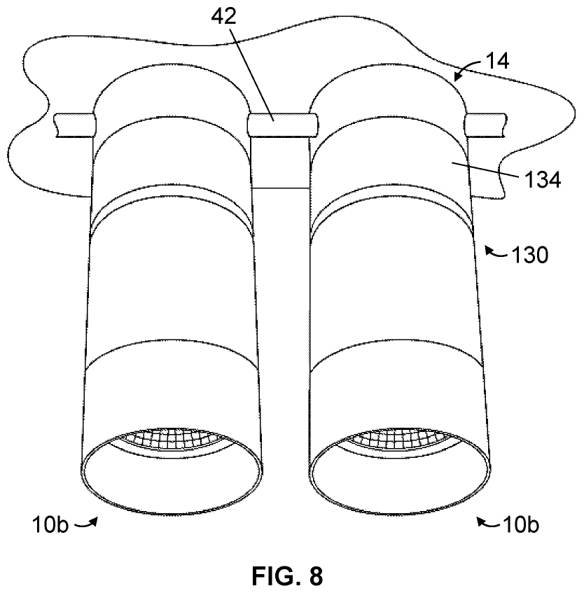

Referring now to FIG. 8, shown is a perspective view of two of apparatus 10b, including one of one or more conduits 42 disposed between and coupled to each of the two apparatuses. As shown, mount 14 is configured to secure one or more conduits 142 relative to the mount, while conduit mounting hardware (e.g., one or more first clamp members 50, one or more second clamp members 62, and/or the like) may be hidden from view when the mount is in use (e.g., when fixture 130 is coupled to the mount, as shown) (e.g., to provide for a visually appealing transition between the one or more conduits and the mount).

Some embodiments of the present methods comprise coupling a second end (e.g., 26) of a mount (e.g., 14) to a surface (e.g., ceiling, wall, floor, other surface, and/or the like), the mount having a sidewall (e.g., 18) extending between the second end and a first end (e.g., 22) that is opposite the second end, inserting a conduit (e.g., 42) into the sidewall and into a first channel (e.g., 54) defined by a first clamp member (e.g., 50) of the mount, coupling a second clamp member (e.g., 62) to the first clamp member to secure the conduit between the first and second clamp members, and coupling a base (e.g., 134) of a fixture (e.g., 130) to the first end of the mount. In some embodiments, the second clamp member defines a second channel (e.g., 66), and the coupling of the second clamp member to the first clamp member is performed such that the conduit is received by the second channel. Such embodiments can be performed in any suitable order; for example, the coupling of the fixture to the mount may be performed before the coupling of the mount to the surface, the inserting the conduit into the mount, and/or the coupling of the second clamp member to the first clamp member.

In some embodiments, the sidewall of the mount defines the outer perimeter (e.g., 36) of the mount, the base of the fixture has an outer perimeter (e.g., 150) that corresponds to the outer perimeter of the mount, and the coupling of the base of the fixture to the first end of the mount is performed such that the outer perimeter of the base aligns with the outer perimeter of the mount. In some embodiments, the coupling of the base of the fixture to the first end of the mount is performed such that the base contacts the sidewall of the mount. Some embodiments comprise coupling a tether (e.g., 126) between the fixture and the mount.

Some embodiments comprise coupling a flange (e.g., 122) to the first end of the mount such that no portion of the flange extends laterally beyond the sidewall of the mount. In some embodiments, one of the base of the fixture and the flange comprises one or more protrusions (e.g., 124), the other of the base and the flange defines one or more slots (e.g., 138), and the coupling of the base of the fixture to the first end of the mount comprises receiving, in each of the one or more slots, a respective one of the one or more protrusions, and rotating the base relative to the flange to couple the base to the mount.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. An apparatus comprising:
a mount comprising:
a first end;
a second end;
a sidewall extending between the first end and the second end to define an interior volume, the sidewall defining the outer perimeter of the mount and one or more openings, each in communication with the interior volume;
one or more first clamp members disposed within the interior volume, each of the one or more first clamp members:
defining a first channel in communication with a respective one of the one or more openings, the first channel configured to receive a conduit; and
being coupled in fixed relation to the sidewall independently of the conduit; and
one or more second clamp members, each configured to be coupled to the second end:
to secure the conduit between the second clamp member and a respective one of the one or more first clamp members; and
such that at least a majority of the second clamp member is disposed between the first end and the first channel of the respective one of the one or more first clamp members; and
a fixture having a base;
where the base of the fixture is configured to be coupled to the first end of the mount.

2. The apparatus of claim 1, where:
the base of the fixture has an outer perimeter that corresponds to the outer perimeter of the mount; and
the base is configured to be coupled to the first end of the mount such that the outer perimeter of the base aligns with the outer perimeter of the mount.

3. The apparatus of claim 5, where the base of the fixture is configured to be coupled to the first end of the mount such that the base contacts the sidewall of the mount.

4. The apparatus of claim 1, where the mount comprises one or more stops, each coupled to a respective one of the clamp members and configured to limit movement of the conduit into the interior volume.

5. An apparatus comprising:
a mount for a fixture, the mount comprising:
a first end configured to be coupled to a fixture;
a second end;
a sidewall extending between the first end and the second end to define an interior volume, the sidewall defining one or more openings, each in communication with the interior volume;
one or more first clamp members disposed within the interior volume, each of the one or more first clamp members:
defining a first channel in communication with a respective one of the one or more openings, the first channel configured to receive a conduit; and
being coupled in fixed relation to the sidewall independently of the conduit;
one or more second clamp members, each configured to be coupled to the second end:
to secure the conduit between the second clamp member and a respective one of the one or more first clamp members; and
such that at least a majority of the second clamp member is disposed between the first end and the first channel of the respective one of the one or more first clamp members; and
one or more stops, each coupled to a respective one of the clamp members and configured to limit movement of the conduit into the interior volume.

6. The apparatus of claim 5, comprising:
a flange configured to be coupled to the first end of the mount such that no portion of the flange extends laterally beyond the sidewall of the mount;
where the flange is configured to be coupled to a fixture.

7. The apparatus of claim 5, where:
the sidewall of the mount defines the outer perimeter of the mount;
the apparatus comprises a fixture having a base with an outer perimeter that corresponds to the outer perimeter of the mount; and
the base is configured to be coupled to the first end of the mount such that the outer perimeter of the base aligns with the outer perimeter of the mount.

8. The apparatus of claim 5, where at least one of the one or more stops is coupled to a respective one of the one or more first clamp members, the stop comprising a projection extending into the first channel.

9. The apparatus of claim 5, where:
each of the one or more second clamp members defines a second channel configured to receive the conduit when the second clamp member is coupled to the respective one of the one or more first clamp members; and
at least one of the one or more stops is coupled to a respective one of the one or more second clamp members, the stop comprising a projection extending into the second channel.

10. The apparatus of claim 9, where the first channel of at least one of the one or more first clamp members includes a cylindrical surface.

11. The apparatus of claim 8, where each of the one or more second clamp members defines a second channel configured to receive the conduit when the second clamp member is coupled to the respective one of the one or more first clamp members.

12. The apparatus of claim 10, where the second channel of at least one of the one or more second clamp members includes a cylindrical surface.

13. The apparatus of claim 5, where, for each of the one or more first clamp members, no portion of the first clamp member extends laterally beyond the sidewall of the mount.

14. The apparatus of claim 13, where, for each of the one or more second clamp members, no portion of the second clamp member extends laterally beyond the sidewall of the mount.

15. The apparatus of claim 5, where no portion of the mount extends laterally beyond the sidewall of the mount.

16. The apparatus of claim 5, where the sidewall of the mount defines a cylindrical surface.

17. The apparatus of claim 1, wherein each of the one or more second clamp members is configured to be coupled to a respective one of the one or more first clamp members.

18. The apparatus of claim 5, wherein each of the one or more second clamp members is configured to be coupled to a respective one of the one or more first clamp members.
